(19) United States
(12) Patent Application Publication
(10) Pub. No.: US 2025/0342179 A1
(43) Pub. Date: Nov. 6, 2025

(54) METHODS AND APPARATUS TO MANAGE INPUT DATA SETS TO REFLECT DATASET MUTATIONS FOR GENAI AND RAG APPLICATIONS

(71) Applicant: Cloudera, Inc., Santa Clara, CA (US)

(72) Inventors: Uma Maheswara Rao Gangumalla, Milpitas, CA (US); Siddharth Jivan Wagle, Saratoga, CA (US); Swaminathan Balachandran, Santa Clara, CA (US); Saketa Chandra Chalamchala, San Jose, CA (US); Karthik Krishnamoorthy, Fremont, CA (US)

(21) Appl. No.: 18/652,240

(22) Filed: May 1, 2024

(51) Int. Cl. G06F 16/31; G06F 16/383

(52) U.S. Cl. CPC G06F 16/31; G06F 16/383

(57) ABSTRACT

Disclosed examples include analyzing a difference report indicative of at least one change between a first snapshot of an input data set in a storage system at a first time and a second snapshot of the input data set in the storage system at a second time; updating a vector index based on a change indicator in the difference report; and sending a refresh notification to a large language model (LLM) query engine based on the update of the vector index.

### FIELD OF THE DISCLOSURE

This disclosure relates generally to computers and, more particularly, to methods and apparatus to manage input data sets to reflect dataset mutations for generative artificial intelligence (GenAI) and retrieval augmented generation (RAG) applications.

### BACKGROUND

In recent years, artificial intelligence (AI) models have been developed for a growing number of uses. Such AI models are trained using training input data sets. An AI model used for recognition of speech is trained using speech data sets. An AI model used for facial recognition is trained using data sets having images of faces. AI models can be trained using many types of training input data sets corresponding to the purposes of those AI models.

### BRIEF DESCRIPTION OF THE DRAWINGS

FIG. 1 is a block diagram of an example environment in which an example snapshot difference (snapdiff) processor operates to identify mutated knowledge bases associated with artificial intelligence (AI) models.

FIG. 2 is an example vector store index that may be used to implement the vector database of FIG. 1 to store an index of documents and corresponding vector embeddings.

FIG. 3 is a block diagram of an example implementation of the snapshot difference processor of FIG. 1.

FIG. 4 is a table showing example actions associated with change indicator entry types of a snapshot difference report.

FIG. 5A is a flowchart representative of example machine-readable instructions and/or example operations that may be executed, instantiated, and/or performed by example programmable circuitry to implement the vector embeddings model of FIG. 1 to build a vector index based on an input data set.

FIG. 5B is a flowchart representative of example machine-readable instructions and/or example operations that may be executed, instantiated, and/or performed by example programmable circuitry to implement the snapshot difference processor of FIG. 3 to update an index of vector embeddings based on differences between snapshots of the storage system of FIG. 1.

FIG. 6 is another flowchart representative of example machine-readable instructions and/or example operations that may be executed, instantiated, and/or performed by example programmable circuitry to implement the snapshot difference processor of FIG. 3 to update an index of vector embeddings based on change notifications from the storage system of FIG. 1.

FIG. 7 is yet another flowchart representative of example machine-readable instructions and/or example operations that may be executed, instantiated, and/or performed by example programmable circuitry to implement the snapshot difference processor of FIG. 3 and the vector embeddings model of FIG. 1 to update an index of vector embeddings based on chunk-level changes of documents in the storage system of FIG. 1.

FIG. 8 is a block diagram of an example processing platform including programmable circuitry structured to execute, instantiate, and/or perform the example machine-readable instructions and/or perform the example operations of FIGS. 5A, 5B, 6, and 7 to implement the snapdiff processor of FIG. 3 and the vector embeddings model of FIG. 1.

FIG. 9 is a block diagram of an example implementation of the programmable circuitry of FIG. 8.

FIG. 10 is a block diagram of another example implementation of the programmable circuitry of FIG. 8.

FIG. 11 is a block diagram of an example software/firmware/instructions distribution platform (e.g., one or more servers) to distribute software, instructions, and/or firmware (e.g., corresponding to the example machine-readable instructions of FIGS. 5A, 5B, 6, and 7) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

FIG. 12 is example pseudocode that represents machine-readable instructions which may be used to create the vector index and the LLM query engine of FIG. 1.

In general, the same reference numbers will be used throughout the drawing(s) and accompanying written description to refer to the same or like parts. The figures are not necessarily to scale.

### DETAILED DESCRIPTION

General artificial intelligence (GenAI) model training and pipeline processes leverage distributed storage systems to store large scale enterprise data. With the rise of GenAI, there are multiple open-source models available in the industry to train unstructured/structured data. In GenAI terminology, a training input data set is referred to as a knowledge base. When a training input data set keeps changing, complex pipeline processing tools are used to understand the knowledge base mutations (e.g., modifications) and to perform retraining with up-to-date training input data sets to produce accurate results.

Examples disclosed herein can be used to efficiently detect only changed documents or changed portions of documents in input data sets used in generative artificial intelligence (GenAI) and retrieval augmented generation (RAG) applications and update only those documents or portions for use in updating vector indexes based on the latest changes automatically without needing to load entire input data sets again from storage systems.

Examples disclosed herein update vector indexes of mutated (e.g., modified) knowledge bases for use by large language models (LLMs) so that such LLMs can generate responses to submitted queries based on up-to-date information. Examples disclosed herein use snapshots of storage systems to identify when documents or portions of documents in input data sets have been modified in those storage systems. Examples disclosed herein use that information to update corresponding vector embeddings in vector index databases.

Examples disclosed herein may be implemented with any suitable type of input data set. For example, the input data set may include text-based files (e.g., documents, spreadsheets, webpages, etc.), audio (e.g., speech files, music files, sound files, etc.), images (e.g., uncompressed image files, compressed image files, high-resolution image files, low-resolution image files, 2-dimensional image files, 3-dimensional image files, etc.), multi-media files, etc. In some examples, an input data set may include a combination of different types of data such as any combination of text-based files, audio files, image files, video files, multi-media files, etc. As such, although some examples disclosed herein may be described with reference to documents, such disclosed examples may be similarly implemented based on any other type of input data set.

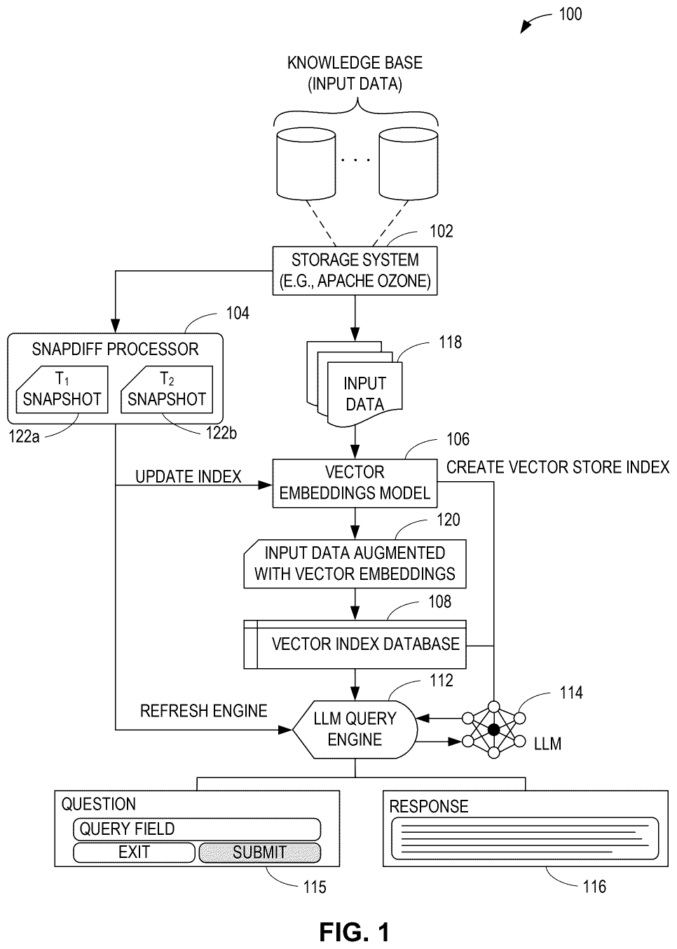

FIG. 1 is a block diagram of an example environment 100 in which an example snapshot difference (snapdiff) processor 104 operates to identify mutated knowledge bases in an example storage system 102 to manage input data sets associated with AI models. In example FIG. 1, the storage system 102 is in communication with the snapdiff processor 104. The storage system 102 is also in communication with a vector embeddings model 106. The vector embeddings model 106 is in communication with an example vector index database 108 (e.g., also referred to herein as a vector index 108). The vector index database 108 and the vector embeddings model 106 are in communication with an example LLM query engine 112. The LLM query engine 112 is in communication with an example LLM 114. The snapdiff processor 104 is in communication with the vector embeddings model 106 and the LLM query engine 112.

Although the vector embeddings model 106 is shown separate from the LLM 114 in FIG. 1, in some examples, the LLM 114 may include the vector embeddings model 106 to generate vector embeddings for the input data set 118 and to generate vector embeddings for user-submitted queries. In other examples, the vector embeddings model 106 is separate from the LLM 114, and the LLM 114 uses the vector embeddings model 106 to cause the vector embeddings model 106 to generate vector embeddings for the input data set 118 and to generate vector embeddings for user-submitted queries.

The storage system 102 stores an example input data set 118, also referred to herein as a knowledge base. The input data set 118 can be used by the LLM 114 to generate responses 116 based on queries 115 submitted by users. For example, the input data set 118 in the storage system 102 may store documents related to any number of subjects. The documents provide the basis of knowledge from which the LLM 114 can synthesize responses 116 relevant to the user submitted queries 115.

In some examples, the storage system 102 may be implemented as a distributed storage system. For example, when an input data set is large, organizations can leverage large scale distributed storage systems to manage such a high volume of data. In some examples, organizations maintain data of different sub-organizations in distributed storage systems even though they have separate independent models running on smaller data sets. The storage system 102 may be implemented using Apache® Ozone which is a highly scalable, distributed object storage system for analytics, big data and cloud native applications made available through The Apache Software Foundation. In other examples, any other suitable storage system architecture (e.g., Amazon® Simple Storage Service (S3) or any suitable S3-compatible system) may be used in addition to or instead of Apache Ozone. In any case, the storage system 102 may be implemented using any suitable hardware such as magnetic storage devices (e.g., magnetic hard disk drives (HDDs), etc.), solid state storage devices (e.g., flash memory, solid state drives (SSDs), etc.), optical storage devices (e.g., digital versatile discs (DVDs), compact discs (CDs), etc.), etc.

The vector embeddings model 106, the vector index 108, the LLM query engine 112, and the LLM 114 are provided to implement Retrieval Augmented Generation (RAG), which is a process to improve responses 116 generated by LLMs (e.g., the LLM 114). RAG is a multi-step process that is also referred to as general artificial intelligence (GenAI) based model training and query engine preparation. To implement RAG, the vector embeddings model 106 accesses and loads the input data set 118 (e.g., a knowledge base) from the storage system 102. In examples disclosed herein, the vector embeddings model 106 is an AI model that is trained to generate vector embeddings based on contents of the documents in the input data set 118. As such, the vector embeddings model 106 builds the vector index 108 based on the loaded documents.

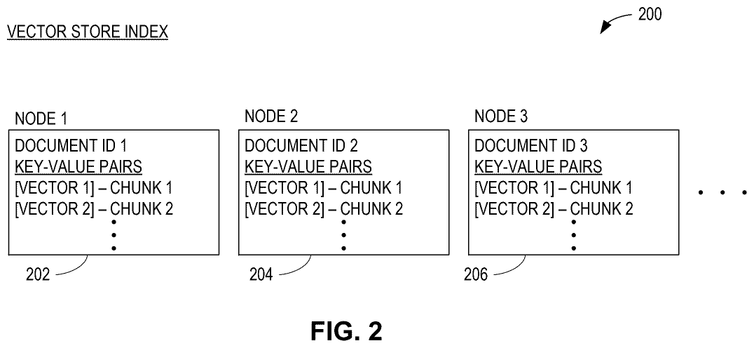

For example, the vector embeddings model 106 generates input data augmented with vector embeddings 120 by parsing contents of documents into multiple chunks of information, generating vector embeddings for each chunk, and associating the vector embeddings with corresponding chunks of those documents. In examples disclosed herein, a chunk of a document may be a word, a phrase, a paragraph, or any other grouping of characters or words for which a vector embedding may be generated to indicate relevance to user-provided queries 115. The vector embeddings model 106 stores the input data augmented with vector embeddings 120 as nodes in the vector index 108, as described below in connection with FIG. 2. The vector index 108 may be implemented using any suitable vector database including serverless vector databases, such as, the Pinecone vector database, which is developed and provided by Pinecone Systems, Inc., San Francisco, California, United States of America. Another example vector database that may be used to implement the vector index 108 is Milvus, an open-source vector database.

After the vector index 108 is ready, the LLM query engine 112 is created based on the vector index 108. The LLM query engine 112 provides an application programming interface (API) so that user devices (e.g., client devices) can submit user-provided queries 115 (e.g., questions) to the LLM query engine 112 and fetch responses 116 generated by the LLM 114 from the LLM query engine 112. For example, when the LLM query engine 112 receives a user-provided query 115, the vector embeddings model 106 analyzes the user-provided query 115 to generate vector embeddings for the contents of the user-provided query 115. The LLM query engine 112 determines a context for the user-provided query 115 by comparing the vector embeddings of the user-provided query 115 to the vector embeddings of the input data set 118 in the vector index 108. In this manner, the LLM query engine 112 identifies chunks of documents having vector embeddings that sufficiently match (e.g., within an acceptable threshold similarity) the vector embeddings of the user-provided query 115 and passes that context to the LLM 114 along with the user-provided query 115. The LLM 114 analyzes the user-provided query 115 against the context to find the most relevant information (e.g., chunks of documents) using the vector embeddings of the input data set 118 in the vector index 108. The LLM 114 uses the identified information in the vector index 108 to synthesize a formatted response 116 for the user-provided query 115. The LLM query engine 112 provides the response 116 to the requesting user device through an API response.

As long as the input data set 118 does not change, the LLM query engine 112 and the LLM 114 continue to provide responses 116 to user queries 115 based on the most up-to-date input data in the vector index 108. However, when changes are made to the input data set 118 in the storage system 102, providing responses 116 by the LLM query engine 112 and the LLM 114 based on the most up-to-date knowledge base relies on the changes to the input data set 118 being propagated from the storage system 102 to the vector index 108. Without knowing where the changes were made in the input data set 118, the entire input data set 118 is retrieved from the storage system 102 and re-indexed, at which time the vector embeddings model 106 re-generates new vector embeddings for the entire input data set 118. This consumes much network bandwidth to retrieve the entire input data set and many compute resources (e.g., processor cycles, memory capacity, etc.) to re-analyze the input data set 118 and re-generate the entire vector index 108. Such resource usage is compounded when frequent changes are made to the input data set 118 in the storage system 102.

Unlike techniques that re-index an entire input data set when a change in the input data set is made, examples disclosed herein provide a snapdiff processor 104 to detect where changes are made in an input data set 118 and re-index select portions of the input data set 118 based on where the changes are detected. In examples disclosed herein, indexing a document of the input data set 118 means to generate new vector embeddings for that document and storing those vector embeddings in the vector index 108 as described below in connection with FIG. 2.

The snapdiff processor 104 uses point-in-time high-speed snapshots to capture data states of the storage system 102 at different times. For example, the snapdiff processor 104 generates a T₁ snapshot 122a of the storage system 102 at a first time (T₁) to be used as a reference snapshot and a T₂ snapshot 122b of the storage system 102 at a later, second time (T₂). The snapdiff processor 104 uses the snapshots 122a,b (e.g., compares the T₂ snapshot 122b to the reference T₁ snapshot 122a) to detect changes in the input data set 118. Based on the detected changes between the two snapshots 122a,b, the snapdiff processor 104 generates a data set difference report (e.g., a snapdiff report). The difference report represents a difference data set indicative of document changes that occurred in the input data set 118 between the T₁ snapshot 122a at the first time (T₁) and the T₂ snapshot 122b at the second time (T₂).

The difference report includes details of changes and corresponding document identifiers (IDs) (e.g., filenames, objectIDs, inodeIDs, etc.). The snapdiff processor 104 analyzes the difference report and identifies previous document IDs from the vector index 108 of documents indicated in the difference report as changed. Based on the detected changes in the difference report, the snapdiff processor 104 inserts or updates specific changed documents in the vector index 108 without affecting other non-changed documents of the input data set 118 in the vector index 108. This conserves network resources by not needing to fetch the entirety of the input data set 118 from the storage system 102 when only one or more documents (e.g., less than all of the documents) have been modified in the input data set 118. Instead, only changed document(s) need to be retrieved from the storage system 102 to generate new vector embeddings and update the vector index 108 with the new vector embeddings of those changed document(s).

For example, if a refresh period (e.g., a snapshot interval) between snapshots of the storage system 102 is 15 minutes (configurable to any suitable interval duration), the T₁ snapshot 122a at the first time (T₁) and the T₂ snapshot 122b at the second time (T₂) are 15 minutes apart (e.g., T₂=T₁+15 minutes). The snapdiff processor 104 determines the snapshot difference (snapdiff) between the T₁ snapshot 122a and the T₂ snapshot 122b and applies snapdiff report change indicator entry actions on the previously created vector index 108. In such examples, the snapdiff processor 104 continues taking snapshots of the storage system 102 every 15 minutes and rolls out (e.g., discards) the older snapshots so that the snapdiff report generated by the snapdiff processor 104 is based on a comparison between the two most recently captures snapshots.

In some examples, instead of comparing snapshots to detect changes in an entire input data set at snapshot interval frequencies, the snapdiff processor 104 may receive modification triggers or notifications from the storage system 102 whenever a modification is made to a document of an input data set in the storage system 102. The snapdiff processor 104 may respond to that modification trigger or interrupt on a per-document basis to cause the vector embeddings model 106 to re-index the modified document in the vector index 108.

The snapdiff processing and per-document updating in the vector index 108 improves the efficiency of an overall GenAI pipeline process. In some examples, the snapdiff processor 104 may be implemented as pluggable so that pipeline automation developers can incorporate custom logic for how detected changes in input data sets are handled. For example, a developer may add custom logic in the snapdiff processor 104 to ignore some file changes. Other example custom logic may select to rebuild the entirety of the vector index 108 based on the latest documents in an input data set, and any new tuning parameters, if changes in the input data set are too significant to limit the update to only some of the documents of the vector index 108.

In some examples, the snapdiff processor 104 may make chunk-level updates to documents in the vector index 108 by comparing checksums of chunks of an outdated document in the vector index 108 with checksums of corresponding chunks in a corresponding modified document in the storage system 102. In this manner, specific chunks or ranges of chunks of a document can be updated in the vector index 108 based on modifications to those chunks in the storage system 102 without affecting other non-modified chunks of the document in the vector index 108. This conserves network resources by not needing to fetch an entire modified document from the storage system 102 and using that entire modified document to replace an older version in the vector index 108. Additional details of chunk-level updates are described below in connection with FIG. 2.

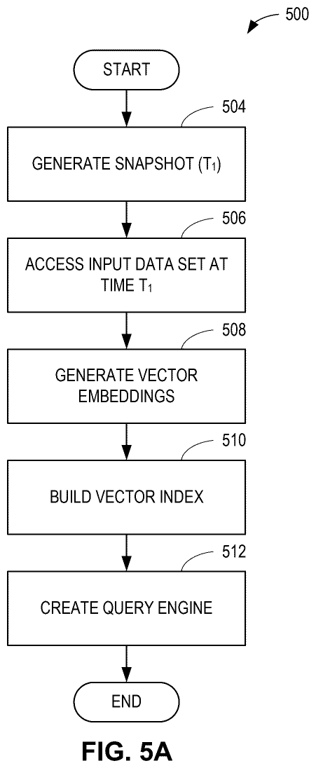

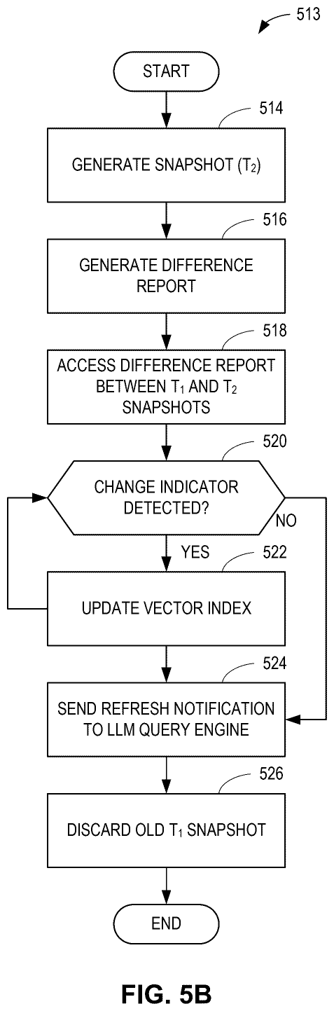

In some examples, the snapdiff processor 104, the vector embeddings model 106, and the LLM query engine 112 of FIG. 1 are circuitry (e.g., storage interface circuitry, snapshot generator circuitry, difference report generator circuitry, change analyzer circuitry, index update notifier circuitry, and query engine update notifier circuitry) instantiated by programmable circuitry executing instructions and/or configured to perform operations such as those represented by the flowcharts of FIGS. 5A, 5B, 6, and 7.

FIG. 2 is an example vector store index 200 (e.g., a VectorStoreIndex) that may be used to implement the vector index 108 of FIG. 1 to store an index of documents and corresponding vector embeddings. In other examples, any other suitable format, instead of a vector store index, for implementing the vector index 108 may be used. In example FIG. 2, an example first node 202, an example second node 204, and an example third node 206 of the vector store index 200 are shown. In other examples, the vector store index 200 may include fewer or more nodes.

Each of the nodes 202, 204, 206 represents a corresponding file (e.g., document) of the input data set 118 of FIG. 1. When building a VectorStoreIndex such as the vector store index 200, document IDs can be assigned to (e.g., using an API to assign document IDs) keep the filename of a document as the document ID. In this manner, documents can be identified by document ID in generated vector store indexes. Based on this document identification organization, a difference report (e.g., a snapdiff report) provides filenames and corresponding details for document changes in the input data set 118.

The nodes 202, 204, 206 and vector embeddings are organized using a two-level index. The first level index is a document-based index. The second level index is a chunk-level index. For the document-based index organization, each node 202, 204, 206 represents a corresponding document from the input data set 118 (FIG. 1) and is assigned a unique document ID (e.g., a filename or any other document identifier). The document ID is a unique document index of a document so that the document can be located at a corresponding node of the vector index 108.

For the chunk-level index, each document in the vector store index 200 is stored as a series of key-value pairs in the corresponding nodes 202, 204, 206. In a key-value pair, the value corresponds to a chunk (e.g., a word, a phrase, a paragraph, etc.) of a document, and the key corresponds to a vector embedding (e.g., vector 1, vector 2, etc.) generated by the vector embeddings model 106 (FIG. 1) for a corresponding chunk. As used herein, a vector is an array of values (e.g., [232, 4, 0, 128, . . . ]) that represent the relevance of a corresponding chunk to particular reference characteristics (e.g., reference words, reference phrases, reference topics, reference expressions, reference paragraphs, etc.) against which the vector was generated. Examples of two key-value pairs are shown for each of the nodes 202, 204, 206 as “[VECTOR 1]—CHUNK 1” and “[VECTOR 2]—CHUNK 2”. In other examples, each node 202, 204, 206 may include fewer or more key-value pairs. The vector index of the key-value pair of a chunk can be used to locate that chunk at a corresponding node of the vector index 108.

Parsing a document into multiple chunks creates more granular vector embeddings for different parts of that document. By organizing document chunks using such key-value pair formatting, different information in the documents can be associated with respective vector embeddings to determine different relevancies of those chunks to different user queries 115 processed by the LLM 114. That is, the LLM 114 uses the vector embeddings (e.g., “VECTOR 1”, “VECTOR 2”, etc.) of the key-value pairs to determine which documents (e.g., the nodes 202, 204, 206) in the vector store index 200 contain information (e.g., chunks) that is most relevant to user-provided queries 115. The LLM 114 selects the most relevant chunk(s) of the documents to synthesize a formatted response 116 for the user-provided query 115.

When the snapdiff processor 104 determines that a document in the input data set 118 has been modified in the storage system 102, the snapdiff processor 104 causes the vector embeddings model 106 to perform a document-level update or a chunk-level update in the vector index 108. For a document-level update, the vector embeddings model 106 generates all new vector embeddings and key-value pairs based on the entirety of the document to which one or more modifications were made in the storage system 102. The vector embeddings model 106 replaces the entirety of the existing key-value-pairs for an outdated document (e.g., in a corresponding node 202, 204, 206) in the vector index 108 based on the newly generated key-value pairs.

For a chunk-level update, the snapdiff processor 104 compares checksums of chunks of an outdated document (e.g., a currently indexed document) in the vector index 108 with checksums of corresponding chunks in a corresponding modified document in the storage system 102. When the snapdiff processor 104 determines that a checksum of a chunk in the outdated document does not match a checksum of a corresponding chunk in the modified document, the snapdiff processor 104 causes the vector embeddings model 106 to re-index that specific chunk from the modified document and update a corresponding key-value pair in a corresponding node (e.g., a node 202, 204, 206) in the vector index 108. In some examples, when the snapdiff processor 104 detects changes in multiple chunks of a modified document based on multiple checksums of the outdated document not matching corresponding multiple checksums of the modified document, the snapdiff processor 104 causes the vector embeddings model 106 to re-index multiple chunks or ranges of chunks of based on the modified chunks of the modified document to replace corresponding key-value pairs in a corresponding node in the vector index 108. The vector embeddings model 106 performs chunk-level updates to replace key-value pairs in the vector index 108 for chunks modified in the storage system 102 without affecting other non-modified chunks of the document in the vector index 108.

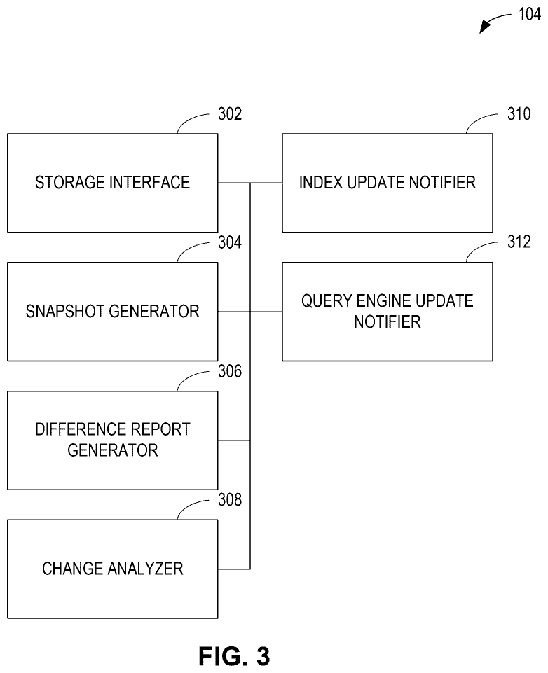

FIG. 3 is a block diagram of an example implementation of the snapdiff processor 104 of FIG. 1 to detect modifications in documents of input data sets and control updating of the vector index 108 (FIG. 1) based on those modifications. The snapdiff processor 104 of FIG. 3 may be instantiated (e.g., creating an instance of, bring into being, materialize, implement, etc.) by programmable circuitry such as a Central Processor Unit (CPU) executing instructions. Additionally or alternatively, the snapdiff processor 104 of FIG. 3 may be instantiated (e.g., creating an instance of, bring into being, materialize, implement, etc.) by (i) an Application Specific Integrated Circuit (ASIC) and/or (ii) a Field Programmable Gate Array (FPGA) structured and/or configured to perform operations of the snapdiff processor 104. It should be understood that some or all of the circuitry of FIG. 3 may be instantiated at the same or different times. Moreover, in some examples, some or all of the circuitry of FIG. 3 may be implemented by microprocessor circuitry executing instructions and/or FPGA circuitry performing operations to implement one or more virtual machines and/or containers.

In example FIG. 3, the snapdiff processor 104 includes an example storage interface 302, an example snapshot generator 304, an example difference report generator 306, an example change analyzer 308, an example index update notifier 310, and an example query engine update notifier 312. In some examples, the storage interface 302, the snapshot generator 304, the difference report generator 306, the change analyzer 308, the index update notifier 310, and the query engine update notifier 312 are circuitry (e.g., storage interface circuitry, snapshot generator circuitry, difference report generator circuitry, change analyzer circuitry, index update notifier circuitry, and query engine update notifier circuitry) instantiated by programmable circuitry executing instructions and/or configured to perform operations such as those represented by the flowcharts of FIGS. 5A, 5B, 6, and 7.

The storage interface 302 is provided to access the storage system 102 and the vector index 108 of FIG. 1. For example, the storage interface 302 may access states of documents or may access individual documents of the input data set 118 in the storage system 102 or in the vector index 108.

The snapshot generator 304 is provided to generate snapshots at different points in time of the storage system 102 to obtain the states of documents in the input data set 118. A snapshot generated by the snapshot generator 304 includes filenames and corresponding file checksums of documents of the input data set 118 in the storage system 102.

The difference report generator 306 is provided to compare snapshots from different points in time (e.g., the T₁ snapshot 122a at the first time (T₁) and the T₂ snapshot 122b at the second time (T₂)) and generate a difference report that includes information indicative of document changes in the input data set 118 (e.g., what documents have been deleted, what documents have been added, what documents have been renamed, what documents have been modified, etc.). For example, the difference report generator 306 may include a comparator (e.g., a comparator circuit and/or comparator software) to compare snapshots. The comparator may determine when a file has been added in the input data set 118 by determining that a filename present in a current snapshot was not present in a previous snapshot. The comparator of the difference report generator 306 may also determine that a file has been deleted from the input data set 118 by determining that a filename present in a previous snapshot is not present in a current snapshot. The comparator of the difference report generator 306 may also determine that a file has been renamed in the input data set 118 by determining that a file checksum of a current snapshot matches a file checksum of a previous snapshot but that the filenames of the files corresponding to those two file checksums do not match. The comparator of the difference report generator 306 may also determine that a file has been modified in the input data set 118 by determining that a file having the same filename in two compared snapshots is associated with a first file checksum in one of the snapshots and a non-matching, second file checksum in the other snapshot.

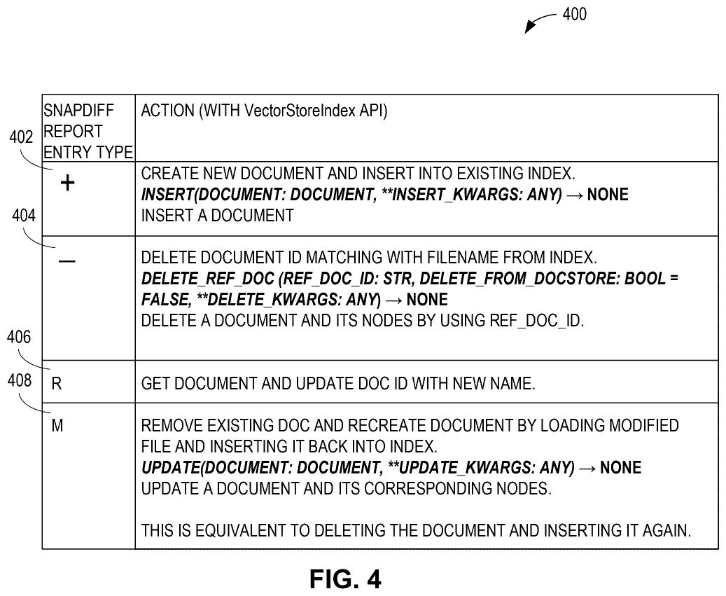

For example, referring briefly to an example snapdiff report entry type table 400 of FIG. 4, different entry types and notations can be used to indicate different types of changes in the input data set 118. A document added change indicator entry type 402 noted by a file-added change indicator (e.g., “+”) indicates that a new document was added to the input data set 118 between the snapshot times of two compared snapshots (e.g., the T₁ snapshot 122a at the first time (T₁) and the T₂ snapshot 122b at the second time (T₂)). For example, the file-added change indicator (“+”) is indicative of a document in the input data set 118 at a second time (T₂) that is not in the input data set 118 at an earlier, first time (T₁). In a difference report, the file-added change indicator (“+”) can be stored in association with file path details of the added file. Based on the file-added change indicator (“+”), the vector index 108 can be updated by inserting the document in the vector index 108.

A document deleted change indicator entry type 404 noted by a file-deleted change indicator (e.g., “−”) indicates that a document was deleted from the input data set 118 between the snapshot times of two compared snapshots. For example, the file-deleted change indicator (“−”) is indicative that a document of the input data set 118 at a first time (“T₁”) is not in the input data set 118 at a later, second time (T₂). In a difference report, the file-deleted change indicator (“−”) can be stored in association with file path details of the deleted file. Based on the file-deleted change indicator (“−”), the vector index 108 can be updated by removing a document ID of the document from the vector index 108. Removing the document ID causes the document to no longer be part of the vector index 108.

A document renamed change indicator entry type 406 noted by a file-renamed change indicator (e.g., “R”) indicates that a file was renamed in the input data set 118 between the snapshot times of two compared snapshots. For example, the file-renamed change indicator (“R”) is indicative of a document having a first name in the input data set 118 at a first time (T₁) and having a second name in the input data set 118 at a later, second time (T₂). In a difference report, the file-renamed change indicator (“R”) can be stored in association with old file path details and new file path details of the renamed file. Based on the file-renamed change indicator (“R”), the vector index 108 can be updated to include an updated document ID corresponding to the name of the renamed file.

A file-modified change indicator entry type 408 noted by a file-modified change indicator (e.g., “M”) indicates that a file was modified in the input data set 118 between the snapshot times of two compared snapshots. For example, the file-modified change indicator (“M”) is indicative of a document of the input data set 118 at a second time (T₂) being a modified version relative to the document in the input data set 118 at an earlier, first time (T₁). In a difference report, the file-modified change indicator (“M”) can be stored in association with file path details of the modified file. Based on the file-modified change indicator (“M”), the vector index 108 can be updated by removing the document corresponding to the first time (T₁) and inserting the modified version of the document in the vector index 108. In other examples, the difference report generator 306 may identify differences using any other suitable entry type in addition to or instead of the entry types 402, 404, 406, 408.

Returning to FIG. 3, the change analyzer 308 is provided to analyze difference reports to determine whether any document changes were made to the input data set 118 between different points in time (e.g., between the T₁ snapshot 122a at the first time (T₁) and the T₂ snapshot 122b at the second time (T₂)). If any document changes were made in the input data set 118, the change analyzer 308 determines the types of changes that were made. For example, the change analyzer 308 can detect change indicator entry types (e.g., the entry types 402, 404, 406, 408 FIG. 4) in difference reports for documents of the input data set 118. The change analyzer 308 notifies the index update notifier 310 of types of changes detected in the difference reports.

The index update notifier 310 is provided to send update index notifications to the vector embeddings model 106 (FIG. 1). For example, responsive to types of changes detected by the change analyzer 308, the index update notifier 310 notifies the vector embeddings model 106 to make corresponding index updates in the vector index 108 at a per-document level or per-chunk level for the input data set 118.

Referring briefly again to example FIG. 4, the update index notifications from the index update notifier 310 can cause the vector embeddings model 106 to apply actions noted in the snapdiff report entry type table 400. For example, for a file-added change indicator entry type 402 (“+”), the vector embeddings model 106 creates a new document and inserts it into the existing vector index 108. To make such a document addition, an example VectorStoreIndex API call shown in FIG. 4 as “INSERT(DOCUMENT: DOCUMENT, **INSERT_KWARGS: ANY)→NONE” may be sent by the index update notifier 310 to the vector embeddings model 106. The vector embeddings model 106 also generates the vector embeddings of the added document in the vector index 108.

For a file-deleted change indicator entry type 404 (“−”), the vector embeddings model 106 deletes a document ID from the vector index 108 that matches a filename of the document detected by the change analyzer 308 as deleted. To make such a document deletion, an example VectorStoreIndex API call shown in FIG. 4 as “DELETE_REF_DOC (REF_DOC_ID: STR, DELETE_FROM_DOCSTORE: BOOL=FALSE, **DELETE_KWARGS: ANY)→NONE” may be sent by the index update notifier 310 to the vector embeddings model 106.

For a file-renamed change indicator entry type 406 (“R”), the vector embeddings model 106 gets a document from the vector index 108 and updates its document ID with a new filename of the document detected by the change analyzer 308 as renamed.

For a file-modified change indicator entry type 408 (“M”), the vector embeddings model 106 removes an existing document in the vector index 108 and recreates the document by loading the modified file from the input data set 118 and inserting the modified file in the vector index 108. For such an action, an example VectorStoreIndex API call shown in FIG. 4 as “UPDATE(DOCUMENT: DOCUMENT, **UPDATE_KWARGS: ANY)→NONE” may be sent by the index update notifier 310 to the vector embeddings model 106. The vector embeddings model 106 also updates the vector embeddings of the modified document in the vector index 108.

Returning to FIG. 3, the query engine update notifier 312 is provided to send refresh engine notifications to the LLM query engine 112. For example, after an update has been made to the vector index 108, a refresh engine notification sent by the query engine update notifier 312 includes a new index object API name of the updated vector index 108. In this manner, the LLM query engine 112 can use the new index object API name to point to the updated version of the vector index 108 when processing user-provided queries (e.g., the user-provided query 115 of FIG. 1) and obtaining relevant information of the input data set 118 from the vector index 108 to generate corresponding responses (e.g., the response 116 of FIG. 1).

The storage system 102, the snapdiff processor 104, the vector embeddings model 106, the vector index database 108, the LLM query engine 112, and the LLM 114 of FIG. 1, and the storage interface 302, the snapshot generator 304, the difference report generator 306, the change analyzer 308, the index update notifier 310, and the query engine update notifier 312 of FIG. 3 are structures. Such structures may implement means for performing corresponding disclosed functions. Examples of such functions are described above in connection with corresponding ones of the storage system 102, the snapdiff processor 104, the vector embeddings model 106, the vector index database 108, the LLM query engine 112, the LLM 114, the storage interface 302, the snapshot generator 304, the difference report generator 306, the change analyzer 308, the index update notifier 310, and the query engine update notifier 312 and are described below in connection with the flowcharts of FIGS. 5A, 5B, 6, and 7.

While an example manner of implementing the storage system 102, the snapdiff processor 104, the vector embeddings model 106, the vector index database 108, the LLM query engine 112, the LLM 114, the storage interface 302, the snapshot generator 304, the difference report generator 306, the change analyzer 308, the index update notifier 310, and the query engine update notifier 312 is illustrated in FIGS. 1 and 3, one or more of the elements, processes, and/or devices illustrated in FIGS. 1 and 3 may be combined, divided, re-arranged, omitted, eliminated, and/or implemented in any other way. Further, the storage system 102, the snapdiff processor 104, the vector embeddings model 106, the vector index database 108, the LLM query engine 112, the LLM 114, the storage interface 302, the snapshot generator 304, the difference report generator 306, the change analyzer 308, the index update notifier 310, and the query engine update notifier 312 of FIGS. 1 and 3, may be implemented by hardware alone or by hardware in combination with software and/or firmware. Thus, for example, any of the storage system 102, the snapdiff processor 104, the vector embeddings model 106, the vector index database 108, the LLM query engine 112, the LLM 114, the storage interface 302, the snapshot generator 304, the difference report generator 306, the change analyzer 308, the index update notifier 310, and the query engine update notifier 312 could be implemented by programmable circuitry in combination with machine-readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example snapdiff processor 104 of FIG. 3 may include one or more elements, processes, and/or devices in addition to, or instead of, those illustrated in FIG. 3, and/or may include more than one of any or all of the illustrated elements, processes and devices.

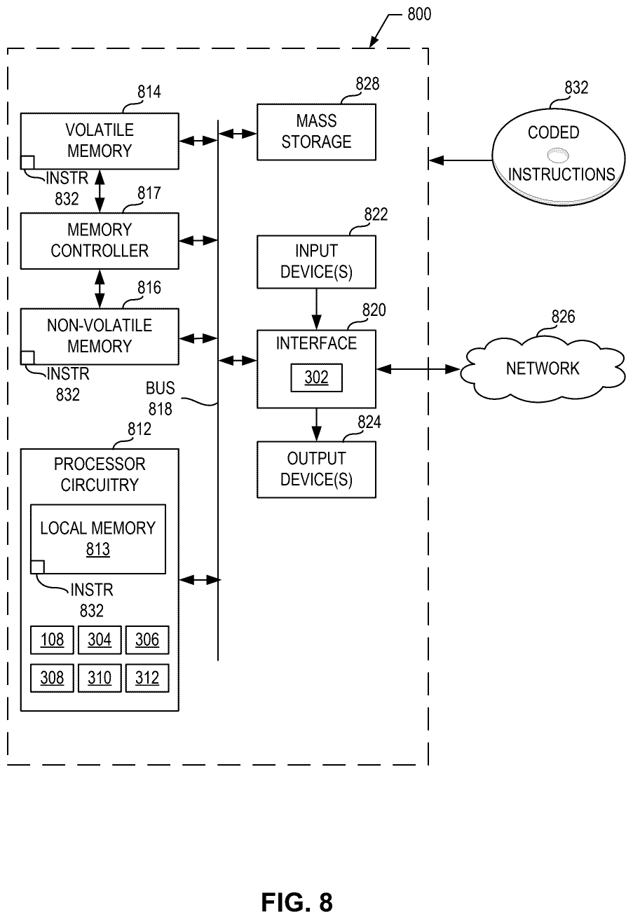

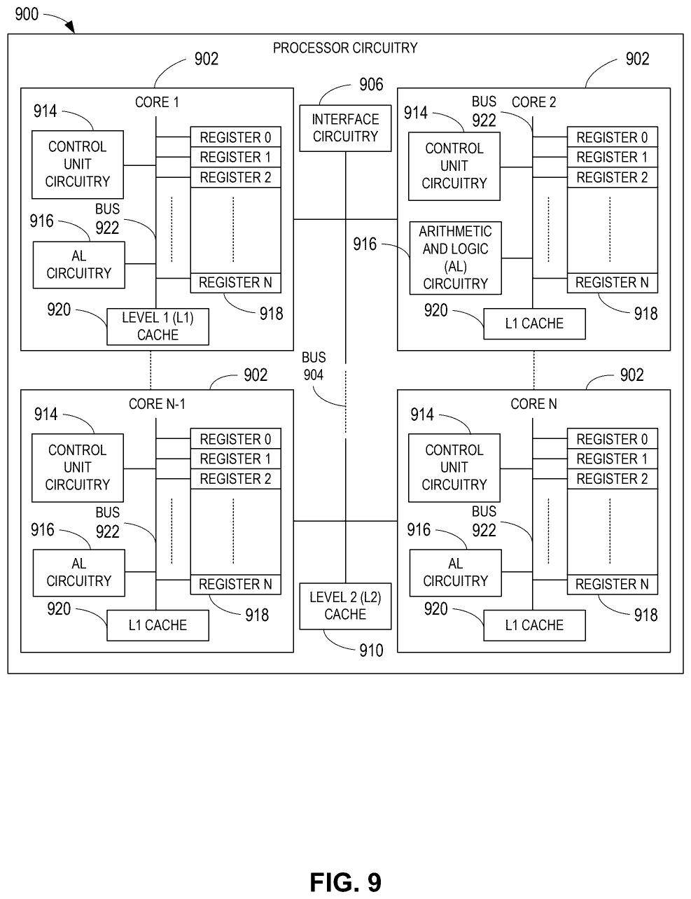

Flowcharts representative of example machine-readable instructions, which may be executed by programmable circuitry to implement and/or instantiate the snapdiff processor 104 of FIG. 3 and/or representative of example operations which may be performed by programmable circuitry to implement and/or instantiate the snapdiff processor 104 of FIG. 3, are shown in FIGS. 5A, 5B, 6, and 7. The machine-readable instructions may be one or more executable program(s) or portion(s) of one or more executable program(s) for execution by programmable circuitry such as the programmable circuitry 812 shown in the example processor platform 800 discussed below in connection with FIG. 8 and/or may be one or more function(s) or portion(s) of functions to be performed by the example programmable circuitry (e.g., an FPGA) discussed below in connection with FIGS. 9 and/or 10. In some examples, the machine-readable instructions cause an operation, a task, etc., to be carried out and/or performed in an automated manner in the real world. As used herein, “automated” means without human involvement.

The program(s) may be embodied in instructions (e.g., software and/or firmware) stored on one or more non-transitory computer readable and/or machine-readable storage media such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, read-only memory (ROM), a solid-state drive (SSD), non-volatile memory (e.g., electrically erasable programmable ROM (EEPROM), flash memory, etc.), volatile memory (e.g., Random Access Memory (RAM) of any type, etc.), and/or any other storage device or storage disk. The non-transitory computer readable storage medium may include one or more mediums and/or types of mediums. The instructions of the non-transitory computer readable and/or machine-readable medium may be executed and/or instantiated by one or more hardware devices other than the programmable circuitry and/or may be embodied in dedicated hardware. For example, any or all of the blocks of the flowchart(s) may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform corresponding operations without executing software or firmware.

Although the example program(s) is/are described with reference to the flowchart(s) illustrated in FIGS. 5A, 5B, 6, and 7, many other methods of implementing the example snapdiff processor 104 may alternatively be used. For example, the order of execution of the blocks of the flowchart(s) may be changed, and/or some of the blocks described may be changed, eliminated, or combined.

The machine-readable instructions may be distributed across multiple hardware devices and/or executed by two or more hardware devices (e.g., a server and a client hardware device). The programmable circuitry may be distributed in different network locations and/or may be local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

Machine-readable instructions as described herein may be stored as data and/or in a data structure (e.g., as portion(s) of instructions, code, representations of code, etc.) on one or more storage devices, disks and/or computing devices (e.g., servers) located at the same or different locations of a network or collection of networks (e.g., in the cloud, in edge devices, etc.).

The machine-readable instructions described herein can be written or represented using any suitable previously developed or future-developed instruction language, scripting language, programming language, etc. including, for example, C, C++, Java, C#, Perl, Python, JavaScript, HyperText Markup Language (HTML), Structured Query Language (SQL), Swift, etc.

As mentioned above, the example operations of FIGS. 5A, 5B, 6, and 7 may be implemented using executable instructions (e.g., computer-readable and/or machine-readable instructions) stored on one or more non-transitory computer-readable and/or machine-readable media. As used herein, the terms non-transitory computer-readable medium, non-transitory computer-readable storage medium, non-transitory machine-readable medium, and/or non-transitory machine-readable storage medium are expressly defined to include any type of computer-readable storage device and/or storage disk and to exclude propagating signals and to exclude transmission media. As used herein, the terms “non-transitory computer-readable storage device” and “non-transitory machine readable storage device” are defined to include any physical (mechanical, magnetic and/or electrical) hardware to retain information for a time period, but to exclude propagating signals and to exclude transmission media. As used herein, the term “device” refers to physical structure such as mechanical and/or electrical equipment, hardware, and/or circuitry that may or may not be configured by computer-readable instructions, machine-readable instructions, etc., and/or manufactured to execute computer-readable instructions, machine-readable instructions, etc. As used herein, the term “storage disk” refers to a physical structure containing information storage elements to which information can be written and persisted for subsequent retrieval by a computer or other hardware platform. Examples of non-transitory computer-readable medium, non-transitory computer-readable storage medium, non-transitory machine-readable medium, non-transitory machine-readable storage medium, non-transitory computer-readable storage devices, non-transitory machine-readable storage devices, non-transitory computer-readable storage disk, and/or non-transitory machine-readable storage disk include any one of or combination of random access memory (RAM) of any type, read only memory (ROM) of any type, solid state memory, flash memory, optical discs (e.g., a CD, a DVD, etc.), magnetic disks (e.g., magnetic HDDs), disk drives, cache, registers, redundant array of independent disks (RAID) systems, and/or any other non-transitory computer-readable and/or machine-readable media in which information is stored for any duration (e.g., for extended time periods, permanently, for brief instances, for temporarily buffering, and/or for caching of the information).

FIG. 5A is a flowchart representative of example machine-readable instructions and/or example operations 500 that may be executed, instantiated, and/or performed by programmable circuitry to implement the vector embeddings model 106 of FIG. 1 to build the vector index 108 based on the input data set 118. The instructions or operations 500 of FIG. 5A are to implement an index build process that is performed to initially create the vector index 108 based on the input data set 118 from the storage system 102. At some later time, an index update process described below in connection with FIG. 5B is performed to make document-level or chunk-level updates to the vector index 108 after analyzing a difference report based on a comparison of snapshots (e.g., the snapshots 122a,b of FIG. 1) of the storage system 102.

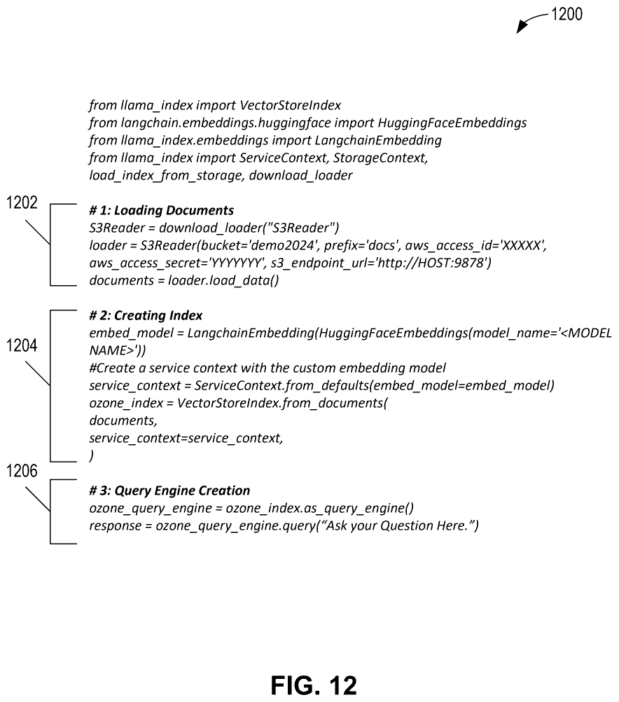

The instructions or operations 500 of FIG. 5A are described in connection with example pseudocode 1200 of FIG. 12 that represents machine-readable instructions which may be used to create the vector index 108 and the LLM query engine 112 of FIG. 1. The example machine-readable instructions and/or the example operations 500 of FIG. 5A begin at block 504 at which the storage system 102 generates a snapshot of the input data set 118 at time T₁ (e.g., at a first time). For example, the storage system 102 generates the T₁ snapshot 122a (FIG. 1) which represents a state of the input data set 118 at time T₁. The T₁ snapshot 122a is stored (e.g., in the storage system 102) as a reference snapshot against which a future snapshot (e.g., the T₂ snapshot 122b) of the input data set 118 will be compared (e.g., at block 516 of FIG. 5B) to determine whether any changes have been made to the input data set 118 between the snapshot times T₁ and T₂. At block 506, the storage interface 302 (FIG. 3) accesses the input data set 118 at a first time (T₁). In some examples, block 506 may be implemented using example “Loading Documents” instructions 1202 of FIG. 12.

The vector embeddings model 106 (FIG. 1) generates vector embeddings based on the documents in the input data set 118 (block 508). The vector embeddings model 106 builds the vector index 108 (block 510). For example, the vector embeddings model 106 generates the input data augmented with vector embeddings 120 (FIG. 1), and stores the input data augmented with vector embeddings 120 in the vector index 108. In some examples, blocks 508 and 510 may be implemented using example “Creating Index” instructions 1204 of FIG. 12.

The vector embeddings model 106 generates a trigger to create the LLM query engine 112 (block 512). For example, when the vector embeddings model 106 is finished creating the vector index 108, the vector embeddings model 106 can generate the trigger to cause instructions executed by processor circuitry to create the LLM query engine 112 based on the vector index 108. In some examples, block 512 may be implemented using example “Query Engine Creation” instructions 1206 of FIG. 12. The instructions or operations 500 of FIG. 5A end.

FIG. 5B is a flowchart representative of example machine-readable instructions and/or example operations 513 that may be executed, instantiated, and/or performed by example programmable circuitry to implement the snapshot difference processor 104 of FIG. 3 to update the vector index 108 of FIG. 1 based on differences between snapshots of the storage system 102 of FIG. 1. The instructions or operations 500 can begin at some time after the instructions or operations 500 of FIG. 5A build the vector index 108. For example, the instructions or operations 500 can build the vector index 108 at time T₁ as described above in connection with FIG. 5A, and the instructions or operations 513 of FIG. 5B can update the vector index 108 at time T₂.

The example instructions or operations begin at block 514, at which the snapshot generator 304 (FIG. 3) generates a snapshot of the input data set 118 at time T₂ (e.g., a second time after the first time T₁ of block 504 of FIG. 5A). For example, the snapshot generator 304 generates the T₂ snapshot 122b of the input data set 118 at time T₂ (e.g., a second time). The difference report generator 306 (FIG. 3) generates a difference report (block 516). For example, the difference report generator 306 generates the difference report (e.g., a snapdiff report) based on differences detected from comparing the T₁ snapshot 122a generated at block 504 of FIG. 5A and the T₂ snapshot 122b generated at block 514.

The change analyzer 308 (FIG. 3) accesses the difference report between the T₁ and T₂ snapshots (block 518). For example, the difference report is indicative of at least one change between the T₁ snapshot 122a of the input data set 118 in the storage system 102 at the first time (T₁) and the T₂ snapshot 122b of the input data set 118 in the storage system 102 at the second time (T₂).

The change analyzer 308 determines whether a change indicator is detected in the difference report (block 520). For example, the change analyzer 308 analyzes entries in the difference report to determine whether one of the change indicator entry types 402, 404, 406, 408 of FIG. 4 is present. If the change analyzer 308 determines that a change indicator is detected in the difference report (block 520: YES), the index update notifier 310 (FIG. 3) causes an update to the vector index 108 (block 522). For example, the index update notifier 310 sends a vector update notification to the vector embeddings model 106 to cause the vector embeddings model 106 to update a document in the vector index 108 based on a change indicator indicative of that document having undergone a change (e.g., a change as described above in connection with FIG. 4). Control returns to block 520. Blocks 520 and 522 may be performed iteratively until all of the change indicators in the difference report have been processed and an updated vector index is generated. When the change analyzer 308 determines that another change indicator is not detected in the difference report (block 520: NO), control advances to block 524. In some examples in which the change analyzer 308 determines that there is no change indicator in the difference report (e.g., the snapshots of times T₁ and T₂ are the same), control advances from block 520 to block 526.

At block 524, the query engine update notifier 312 (FIG. 3) sends a refresh notification to the LLM query engine 112 based on the update of the vector index 108. For example, the vector index 108 is associated with a first index object API name when the vector index 108 is built at block 510. Subsequently, when the index update notifier 310 causes the vector embeddings model 106 to generate an updated vector index 108, the refresh notification to the LLM query engine 112 includes a second index object API name corresponding to the updated vector index 108. In this manner, when the query engine update notifier 312 sends a refresh notification with an updated index object API name, the LLM query engine 112 can use the updated index object API name to access the updated version of the vector index 108. The LLM query engine 112 can then use the updated vector embeddings in the updated vector index 108 when processing subsequent user-submitted queries.

The snapshot generator 304 discards the old T₁ snapshot 122a (block 526). For example, the old T₁ snapshot 122a will no longer be used for a subsequent comparison. Instead, the most recent T₂ snapshot 122b generated at block 514 becomes the new reference snapshot against which a future snapshot (e.g., a T₃ snapshot) of the input data set 118 will be compared to determine whether any changes have been made to the input data set between the snapshot times T₂ and T₃. The example instructions 513 of FIG. 5B end.

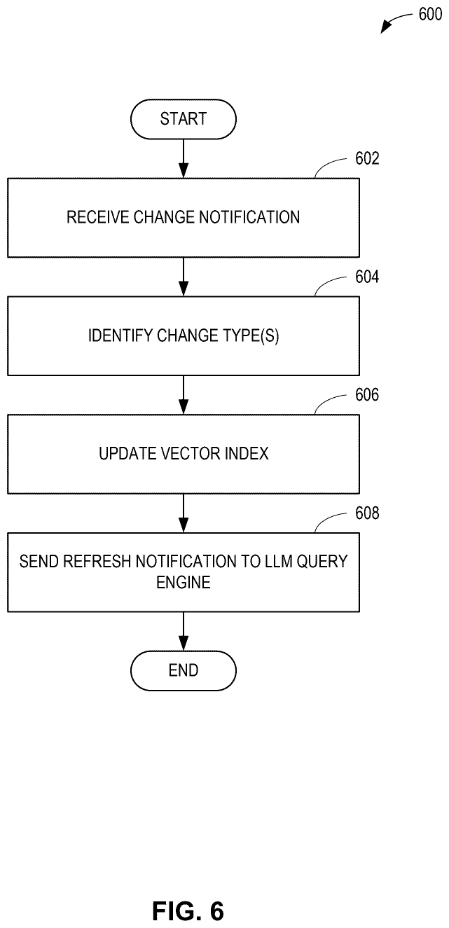

FIG. 6 is a flowchart representative of example machine-readable instructions and/or example operations 600 that may be executed, instantiated, and/or performed by example programmable circuitry to implement the snapdiff processor 104 of FIG. 3 to update the vector index 108 (FIG. 1) based on change notifications from the storage system 102 of FIG. 1. For example, instead of creating the snapshots 122a,b of FIG. 1 to update the vector index 108 based on a set timing between the two snapshots 122a,b, the snapdiff processor 104 can receive ongoing change notifications from the storage system 102 whenever the storage system 102 detects that a document change has been made to the input data set 118. In this manner, the snapdiff processor 104 can cause the vector embeddings model 106 to make incremental updates to the vector index 108 in substantially real time relative to when document changes are made or detected in the storage system 102.

The instructions 600 begin at block 602 at which the storage interface 302 (FIG. 3) receives a change notification from the storage system 102. For example, the change notification is indicative of a document change detected by the storage system 102 to the input data set 118. The change notification may include any one or more of the change indicators described above in connection with FIG. 4. The change analyzer 308 (FIG. 3) identifies the change type(s) in the change notification (block 604). The index update notifier 310 (FIG. 3) causes an update to the vector index 108 (block 606). For example, the index update notifier 310 sends a vector update notification to the vector embeddings model 106 to cause the vector embeddings model 106 to update one or more documents in the vector index 108 based on the change type(s) indicative of the document(s) having undergone a change (e.g., a change as described above in connection with FIG. 4).

The query engine update notifier 312 (FIG. 3) sends a refresh notification to the LLM query engine 112 based on the update of the vector index 108 (block 608). For example, when the index update notifier 310 causes the vector embeddings model 106 to update the vector index 108, the vector embeddings model 106 generates an updated vector index 108. The refresh notification to the LLM query engine 112 includes an updated index object API name corresponding to the updated vector index 108. In this manner, when the query engine update notifier 312 sends a refresh notification with an updated index object API name, the LLM query engine 112 can use the updated index object API name to access the updated version of the vector index 108. The LLM query engine 112 can then use the updated vector embeddings in the updated vector index 108 when processing subsequent user-submitted queries. The example instructions 600 of FIG. 6 end.

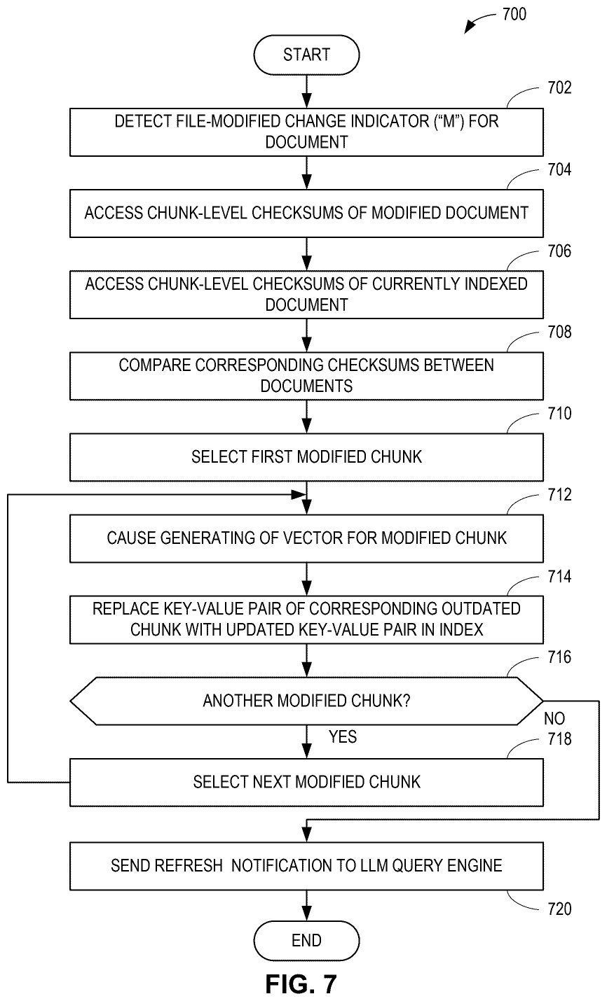

FIG. 7 is another flowchart representative of example machine-readable instructions and/or example operations 700 that may be executed, instantiated, and/or performed by example programmable circuitry to implement the snapdiff processor 104 of FIG. 3 and the vector embeddings model 106 of FIG. 1 to update the vector index 108 based on chunk-level changes of documents in the storage system 102 of FIG. 1. For example, instead of generating new vector embeddings for an entire document when a document has been modified, the instructions 700 can be used to update vector embeddings of only changed chunk(s) of a document.

The instructions 700 begin at block 702 at which the change analyzer 308 (FIG. 3) detects a file-modified change indicator (“M”) for a document. The storage interface 302 (FIG. 3) accesses chunk-level checksums of a modified document from the storage system 102 (block 704). The storage interface 302 accesses chunk-level checksums of a corresponding currently indexed document in the vector index 108 (block 706). The change analyzer 308 (FIG. 3) compares corresponding checksums between the two documents (block 708). For example, the change analyzer 308 performs chunk-level comparisons between corresponding chunks of the documents to determine what chunks of the modified document in the storage system 102 have been modified relative to chunks of the currently indexed document in the vector index 108. Accordingly, on a per-chunk basis, the change analyzer 308 compares a first checksum of a first chunk (e.g., a currently indexed chunk) of the currently indexed document (e.g., corresponding to a first time) with a second checksum of a second chunk (e.g., a modified chunk) of the modified document (e.g., corresponding to a second time). In such examples, the first chunk of the currently indexed document corresponds to the second chunk of the modified document (e.g., the chunks are at the same locations in their respective documents, the chunks have significant matching portions except for one or more modifications, the chunks are keyed with a same paragraph number in their respective documents, etc.).

The change analyzer 308 selects a first modified chunk (block 710). For example, after determining at block 708 that the second checksum corresponding to the second time is different from the first checksum corresponding to the first time, the change analyzer 308 selects a chunk corresponding to the detected chunk-level modification. The index update notifier 310 (FIG. 3) causes the vector embeddings model 106 to generate a vector for a first modified chunk (block 712). The vector embeddings model 106 replaces a key-value pair of a corresponding outdated chunk with an updated key-value pair in the vector index 108 (block 714). For example, the index update notifier 310 causes the vector embeddings model 106 to replace the first chunk (e.g., the currently indexed chunk) and a corresponding vector (e.g., an outdated key-value pair) in the vector index 108 with the second chunk (e.g., the modified chunk) of the modified document and a corresponding vector (e.g., an updated key-value pair) in the vector index 108 without replacing others of the chunks of the currently indexed document in the vector index 108.

The change analyzer 308 determines whether another modified chunk was detected (block 716). If another modified chunk was detected based on the comparisons at block 708 (block 716: YES), the change analyzer 308 selects the next modified chunk (block 718), and control returns to block 712. If another modified chunk was not detected (block 716: NO), control advances to block 720. At block 720, the query engine update notifier 312 (FIG. 3) send a refresh notification to the LLM query engine 112 based on the update of the vector index 108. For example, when the index update notifier 310 causes the vector embeddings model 106 to update vectors of one or more chunks in the vector index 108, the vector embeddings model 106 generates an updated vector index 108. The refresh notification to the LLM query engine 112 includes an updated index object API name corresponding to the updated vector index 108. In this manner, when the query engine update notifier 312 sends a refresh notification with an updated index object API name, the LLM query engine 112 can use the updated index object API name to access the updated version of the vector index 108. The LLM query engine 112 can then use the updated vector embeddings in the updated vector index 108 when processing subsequent user-submitted queries. The example instructions 700 of FIG. 7 end.

FIG. 8 is a block diagram of an example programmable circuitry platform 800 structured to execute and/or instantiate the example machine-readable instructions and/or the example operations of FIGS. 5A, 5B, 6, and 7 to implement the snapdiff processor 104 of FIG. 3. The programmable circuitry platform 800 can be, for example, a server, a personal computer, a workstation, a self-learning machine (e.g., a neural network), or any other type of computing and/or electronic device.

The programmable circuitry platform 800 of the illustrated example includes programmable circuitry 812. The programmable circuitry 812 of the illustrated example is hardware. For example, the programmable circuitry 812 can be implemented by one or more integrated circuits, logic circuits, FPGAs, microprocessors, CPUs, GPUs, DSPs, XPUs, and/or microcontrollers from any desired family or manufacturer. The programmable circuitry 812 may be implemented by one or more semiconductor based (e.g., silicon based) devices. In this example, the programmable circuitry 812 implements the vector embeddings model 106 of FIG. 1 and the snapshot generator 304, the difference report generator 306, the change analyzer 308, the index update notifier 310, and the query engine update notifier 312 of FIG. 3.

The programmable circuitry 812 of the illustrated example includes a local memory 813 (e.g., a cache, registers, etc.). The programmable circuitry 812 of the illustrated example is in communication with main memory 814, 816, which includes a volatile memory 814 and a non-volatile memory 816, by a bus 818. The volatile memory 814 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 816 may be implemented by flash memory and/or any other desired type of memory device. Access to the main memory 814, 816 of the illustrated example is controlled by a memory controller 817. In some examples, the memory controller 817 may be implemented by one or more integrated circuits, logic circuits, microcontrollers from any desired family or manufacturer, or any other type of circuitry to manage the flow of data going to and from the main memory 814, 816.

The programmable circuitry platform 800 of the illustrated example also includes interface circuitry 820. The interface circuitry 820 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface. In the illustrated example, the interface circuitry 820 implements the storage interface 302 of FIG. 3.

In the illustrated example, one or more input devices 822 are connected to the interface circuitry 820. The input device(s) 822 permit(s) a user (e.g., a human user, a machine user, etc.) to enter data and/or commands into the programmable circuitry 812. The input device(s) 822 can be implemented by, for example, a keyboard, a button, a mouse, a touchscreen, a trackpad, and/or a trackball.

One or more output devices 824 are also connected to the interface circuitry 820 of the illustrated example. The output device(s) 824 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 820 of the illustrated example, thus, typically includes a graphics driver card, a graphics driver chip, and/or graphics processor circuitry such as a GPU.

The interface circuitry 820 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 826. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 800 of the illustrated example also includes one or more mass storage discs or devices 828 to store firmware, software, and/or data. Examples of such mass storage discs or devices 828 include magnetic storage devices, optical storage devices, RAID systems, and/or solid-state storage discs or devices such as flash memory devices and/or SSDs.

The machine-readable instructions 832, which may be implemented by the machine-readable instructions of FIGS. 5A, 5B, 6, and 7, may be stored in the mass storage device 828, in the volatile memory 814, in the non-volatile memory 816, and/or on at least one non-transitory computer readable storage medium which may be removable.

FIG. 9 is a block diagram of an example implementation of the programmable circuitry 812 of FIG. 8. In this example, the programmable circuitry 812 of FIG. 8 is implemented by a microprocessor 900. For example, the microprocessor 900 may be a general-purpose microprocessor (e.g., general-purpose microprocessor circuitry). The microprocessor 900 and/or components thereof may include additional and/or alternate structures to those shown and described below. The microprocessor 900 is a semiconductor device fabricated to include transistors interconnected to implement the structures described below in one or more integrated circuits (ICs) contained in one or more packages.

The microprocessor 900 executes machine-readable instructions of the flowcharts of FIGS. 5A, 5B, 6, and 7 to instantiate the circuitry of FIG. 3 as logic circuits to perform operations corresponding to those machine-readable instructions. In some such examples, the circuitry of FIG. 3 is instantiated by the hardware circuits of the microprocessor 900 in combination with the machine-readable instructions. For example, the microprocessor 900 may be implemented by multi-core hardware circuitry such as a CPU, a DSP, a GPU, an XPU, etc. Although it may include any number of example cores 902 (e.g., 1 core), the microprocessor 900 of this example is a multi-core semiconductor device including N cores. The cores 902 of the microprocessor 900 may operate independently or may cooperate to execute machine-readable instructions. For example, machine code corresponding to a firmware program, an embedded software program, or a software program represented by the flowchart(s) of FIGS. 5-7 may be executed by one of the cores 902 or may be executed by multiple ones of the cores 902 at the same or different times. In some examples, the machine code corresponding to the firmware program, the embedded software program, or the software program is split into threads and executed in parallel by two or more of the cores 902. The software program may correspond to a portion or all of the machine readable instructions and/or operations represented by the flowcharts of FIGS. 5A, 5B, 6, and 7.

The cores 902 may communicate by a first example bus 904. For example, the first bus 904 may be implemented by any suitable bus technology (e.g., an Inter-Integrated Circuit (I2C) bus, a Serial Peripheral Interface (SPI) bus, a PCI bus, a PCIe bus etc.). Data, instructions, and/or signals may be communicated (e.g., accessed, obtained, output, provided, etc.) between the cores 902 and one or more external devices by example interface circuitry 906. Although the cores 902 of this example include example local cache 920 (e.g., Level 1 (L1) cache that may be split into an L1 data cache and an L1 instruction cache), the microprocessor 900 also includes example shared cache 910. The shared cache 910 is shared by the cores (e.g., Level 2 (L2 cache)) to access data and/or instructions across the cores.

Each core 902 includes control unit circuitry 914, arithmetic and logic (AL) circuitry (sometimes referred to as an arithmetic logic unit (ALU)) 916, a plurality of registers 918 (e.g., hardware registers), the local cache 920, and a second example bus 922. The control unit circuitry 914 controls (e.g., coordinates) data movement within the corresponding core 902. The AL circuitry 916 performs one or more mathematic and/or logic operations on the data within the corresponding core 902.

The registers 918 store data and/or instructions such as results of operations performed by the AL circuitry 916. The second bus 922 may be implemented using any suitable bus technology (e.g., an I2C bus, a SPI bus, a PCI bus, or a PCIe bus, etc.).

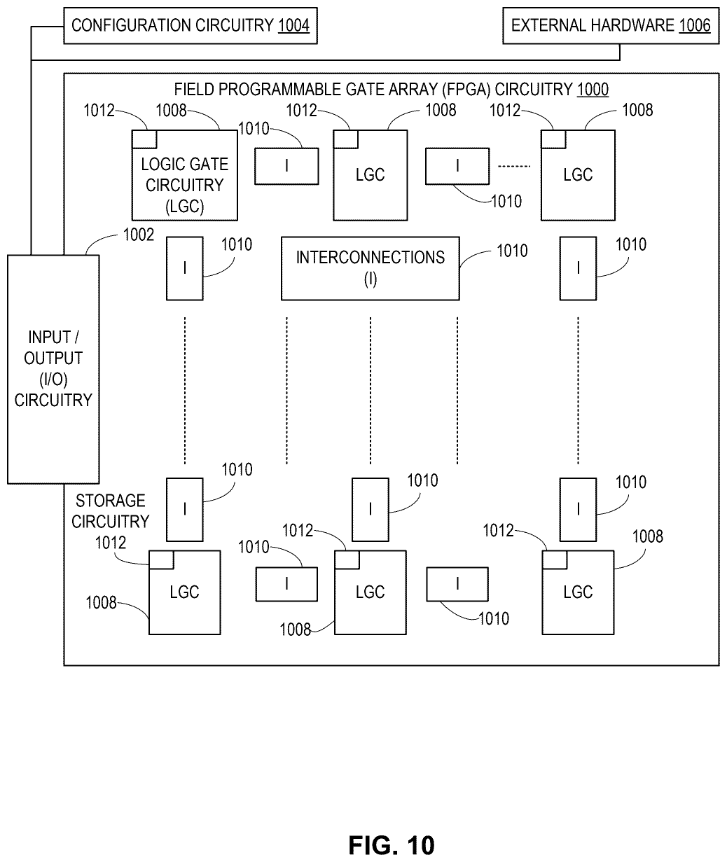

FIG. 10 is a block diagram of another example implementation of the programmable circuitry 812 of FIG. 8. In this example, the programmable circuitry 812 is implemented by FPGA circuitry 1000. Programmable logic circuitry of the FPGA circuitry 1000 may be programmed to create dedicated logic circuits that perform operations and/or functions represented in the flowchart(s) of FIGS. 5-7. For example, the FPGA circuitry 1000 includes interconnections and logic circuitry (e.g., logic gates, switches, etc.) that may be configured, structured, programmed, and/or interconnected in different ways to instantiate some or all of the operations/functions corresponding to the machine-readable instructions represented by the flowchart(s) of FIGS. 5A, 5B, 6, and 7. After an FPGA programming process, the FPGA circuitry 1000 instantiates the operations and/or functions corresponding to the machine-readable instructions in hardware. In some examples, the FPGA circuitry 1000 can execute the operations/functions faster than they could be performed by a general-purpose microprocessor.

The FPGA circuitry 1000 of FIG. 10, includes example input/output (I/O) circuitry 1002 to obtain data from and/or output data to example configuration circuitry 1004 and/or external hardware 1006 (e.g., microprocessor circuitry, controller circuitry, memory circuitry, storage circuitry, a computer, etc.). For example, the configuration circuitry 1004 may be implemented by interface circuitry that obtains a binary file to program or configure the FPGA circuitry 1000.

The FPGA circuitry 1000 also includes an array of example logic gate circuitry 1008, a plurality of example configurable interconnections 1010, and example storage circuitry 1012. The logic gate circuitry 1008 and the configurable interconnections 1010 are configurable to instantiate one or more operations/functions that may correspond to machine-readable instructions of FIGS. 5A, 5B, 6, and 7 and/or other desired operations.

The storage circuitry 1012 is structured to store result(s) of operations performed by corresponding logic gates. The storage circuitry 1012 may be implemented by registers or the like.

Although not shown, the example FPGA circuitry 1000 of FIG. 10 also includes example dedicated operations circuitry to implement functions without programming those functions in the logic gate circuitry 1008. The FPGA circuitry 1000 may also include general purpose programmable circuitry such as a CPU, a DSP, etc.

Although FIGS. 9 and 10 illustrate two example implementations of the programmable circuitry 812 of FIG. 8, many other approaches are contemplated. For example, a hybrid circuitry example may include one or more cores 902 of FIG. 9 that execute(s) a first portion of the machine-readable instructions represented by the flowchart(s) of FIGS. 5A, 5B, 6, and 7 to perform first operation(s)/function(s), and/or include the FPGA circuitry 1000 of FIG. 10 configured and/or structured to perform second operation(s)/function(s) corresponding to a second portion of the machine-readable instructions represented by the flowcharts of FIG. 5-7, and/or include an ASIC configured and/or structured to perform third operation(s)/function(s) corresponding to a third portion of the machine-readable instructions represented by the flowcharts of FIGS. 5A, 5B, 6, and 7.

As used herein, integrated circuit/circuitry is defined as one or more semiconductor packages containing one or more circuit elements such as transistors, capacitors, inductors, resistors, current paths, diodes, etc. For example, an integrated circuit may be implemented as one or more of an ASIC, an FPGA, a chip, a microchip, programmable circuitry, a semiconductor substrate coupling multiple circuit elements, a system on chip (SoC), etc.

In some examples, the programmable circuitry 812 of FIG. 8 may be in one or more packages. For example, the microprocessor 900 of FIG. 9 and/or the FPGA circuitry 1000 of FIG. 10 may be in one or more packages.

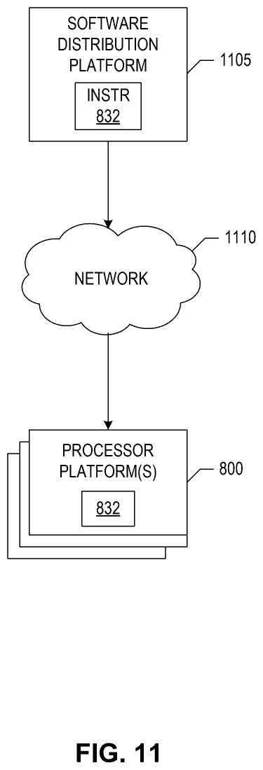

A block diagram illustrating an example software distribution platform 1105 to distribute software such as the example machine-readable instructions 832 of FIG. 8 to other hardware devices (e.g., hardware devices owned and/or operated by third parties from the owner and/or operator of the software distribution platform) is illustrated in FIG. 11. The example software distribution platform 1105 may be implemented by any computer server, data facility, cloud service, etc., capable of storing and transmitting software to other computing devices. The third parties may be customers of the entity owning and/or operating the software distribution platform 1105. In the illustrated example, the software distribution platform 1105 includes one or more servers and one or more storage devices. The storage devices store the machine-readable instructions 832, which may correspond to the example machine-readable instructions of FIGS. 5A, 5B, 6, and 7, as described above. The one or more servers of the example software distribution platform 1105 are in communication with an example network 1110, which may correspond to any one or more of the Internet and/or any of the example networks described above. The servers enable downloading the machine-readable instructions 832 from the software distribution platform 1105. Although referred to as software above, the distributed “software” could alternatively be firmware.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

As used herein “substantially real time” refers to an occurrence in a near instantaneous manner recognizing there may be real-world delays for computing time, transmission, etc. Thus, unless otherwise specified, “substantially real time” refers to real time+1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include any circuitry that can be programmed or configured to perform different operations and that includes one or more semiconductor-based logic devices (e.g., electrical hardware implemented by one or more transistors. Programmable circuitry may be: (i) one or more special purpose electrical circuits (e.g., an ASIC) and/or (ii) one or more general purpose semiconductor-based electrical circuits programmable with instructions. Examples of programmable circuitry include programmable microprocessors such as CPUs, FPGAs, GPUs, DSPs, XPUs, Network Processing Units (NPUs), and/or integrated circuits such as ASICs. For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing tasks to whichever one(s) of the multiple types of programmable circuitry is/are suited and available to perform the computing tasks.

From the foregoing, it will be appreciated that example systems, apparatus, articles of manufacture, and methods have been disclosed that manage input data sets. Disclosed systems, apparatus, articles of manufacture, and methods improve the efficiency of using a computing device by improving the efficiency of an overall GenAI pipeline process. Example improvements include conserving network resources by not needing to fetch an entire input data set from a storage system when only one or more documents are modified. Instead, only modified documents or modified chunks of documents of an input data set need to be retrieved from the storage system to generate vector embeddings for only those modified documents or modified chunks of documents and to update a vector index. Disclosed systems, apparatus, articles of manufacture, and methods are accordingly directed to one or more improvement(s) in the operation of a machine such as a computer or other electronic and/or mechanical device.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

1. An apparatus comprising:
interface circuitry to access a difference report indicative of at least one change between a first snapshot of an input data set in a storage system at a first time and a second snapshot of the input data set in the storage system at a second time;
machine-readable instructions; and
programmable circuitry to be programmed by the machine-readable instructions to:
in response to the at least one change indicated in the difference report, re-index a first portion of a previously generated vector index without re-indexing a second portion of the vector index to update the vector index by:
generating a vector embedding for a document of the input data set without generating vector embeddings for other documents of the input data set; and
re-indexing the first portion of the vector index based on the vector embedding without re-indexing the second portion of the vector index;
cause sending of a refresh notification to a large language model (LLM) query engine based on the update to the vector index; and
cause the LLM query engine, based on receiving the refresh notification, to use the updated vector index to process a query.

2. The apparatus of claim 1, wherein the document is represented in the vector index as chunks and corresponding vectors, the programmable circuitry to update the vector index by:
comparing a first checksum of a first chunk of the document corresponding to a third time with a second checksum of a second chunk of the document corresponding to a fourth time; and
after determining that the second checksum is different from the first checksum, causing replacement of the first chunk and a corresponding first vector in the vector index by the second chunk and a corresponding second vector without replacing others of the chunks of the document in the vector index.

3. The apparatus of claim 1, wherein the at least one change indicated in the difference report is represented by a change indicator in the difference report, the change indicator is indicative of the document having a first name in the input data set at the first time and having a second name in the input data set at the second time, the programmable circuitry to generate the vector embedding by generating an updated document identifier corresponding to the second name of the document.

4. The apparatus of claim 1, wherein the difference report includes a change indicator indicative of a second document of the input data set at the second time being a modified version relative to the second document in the input data set at the first time, the programmable circuitry to cause an update to the vector index by removing the second document corresponding to the first time and inserting the modified version of the second document in the vector index.

5. The apparatus of claim 1, wherein the difference report includes a change indicator indicative of a second document in the input data set at the second time that is not in the input data set at the first time, the programmable circuitry to cause an update to the vector index by inserting the second document in the vector index.

6. The apparatus of claim 1, wherein the difference report includes a change indicator indicative that a second document of the input data set at the first time is not in the input data set at the second time, the programmable circuitry to cause an update to the vector index by removing a document identifier of the second document from the vector index.

7. The apparatus of claim 1, wherein the vector index includes a first index object application programming interface (API) name, the refresh notification to the LLM query engine including a second index object API name corresponding to the updated vector index.

8. At least one non-transitory machine-readable medium comprising machine-readable instructions to cause at least one processor circuit to at least:
analyze a difference report indicative of at least one change between a first snapshot of an input data set in a storage system at a first time and a second snapshot of the input data set in the storage system at a second time;
in response to the at least one change indicated in the difference report, re-index a first portion of an existing vector index without re-indexing a second portion of the vector index by:
generating a vector embedding for a document of the input data set without generating vector embeddings for other documents of the input data set; and
re-indexing the first portion of the vector index based on the vector embedding without re-indexing the second portion of the vector index;
cause sending of a refresh notification to a large language model (LLM) query engine based on the re-indexed first portion of the vector index; and
cause the LLM query engine, based on receipt of the refresh notification, to use the vector index with the re-indexed first portion to process a query.

9. The at least one non-transitory machine-readable medium of claim 8, wherein the document is represented in the vector index as chunks and corresponding vectors, the machine-readable instructions to cause one or more of the at least one processor circuit to update the vector index by:
comparing a first checksum of a first chunk of the document corresponding to a third time with a second checksum of a second chunk of the document corresponding to a fourth time; and
after determining that the second checksum is different from the first checksum, causing replacement of the first chunk and a corresponding first vector in the vector index by the second chunk and a corresponding second vector without replacing others of the chunks of the document in the vector index.

10. The at least one non-transitory machine-readable medium of claim 8, wherein the at least one change indicated in the difference report is represented by a change indicator in the difference report, the change indicator is indicative of the document having a first name in the input data set at the first time and having a second name in the input data set at the second time, the machine-readable instructions to cause one or more of the at least one processor circuit to generate the vector embedding by generating an updated document identifier corresponding to the second name of the document.

11. The at least one non-transitory machine-readable medium of claim 8, wherein the difference report includes a change indicator indicative of a second document of the input data set at the second time being a modified version relative to the second document in the input data set at the first time, the machine-readable instructions to cause one or more of the at least one processor circuit to cause an update of the vector index by removing the second document corresponding to the first time and inserting the modified version of the second document in the vector index.

12. The at least one non-transitory machine-readable medium of claim 8, wherein the difference report includes a change indicator indicative of a second document in the input data set at the second time that is not in the input data set at the first time, the machine-readable instructions to cause one or more of the at least one processor circuit to cause an update of the vector index by inserting the second document in the vector index.

13. The at least one non-transitory machine-readable medium of claim 8, wherein the difference report includes a change indicator indicative that a second document of the input data set at the first time is not in the input data set at the second time, the machine-readable instructions to cause one or more of the at least one processor circuit to cause an update of the vector index by removing a document identifier of the second document from the vector index.

14. The at least one non-transitory machine-readable medium of claim 8, wherein the vector index with the re-indexed first portion is an updated vector index, the vector index having a first index object application programming interface (API) name, the machine-readable instructions to cause one or more of the at least one processor circuit to include a second index object API name corresponding to the updated vector index in the refresh notification to the LLM query engine.

15. A method comprising:
analyzing a difference report indicative of at least one change between a first snapshot of an input data set in a storage system at a first time and a second snapshot of the input data set in the storage system at a second time;
in response to the at least one change indicated in the difference report, re-indexing a first portion of an existing vector index without re-indexing a second portion of the vector index by:
generating a vector embedding for the first portion of the input data set corresponding to the change without generating a vector embedding for the second portion of the input data set; and
re-indexing the first portion of the vector index based on the vector embedding without re-indexing the second portion of the vector index;
sending a refresh notification to a large language model (LLM) query engine based on the re-indexed first portion of the vector index; and
based on receiving the refresh notification at the LLM query engine, using the vector index with the re-indexed first portion at the LLM query engine to process a query.

16. The method of claim 15, wherein a document is represented in the vector index as chunks and corresponding vectors, the method including updating the vector index by:
comparing a first checksum of a first chunk of the document corresponding to a third time with a second checksum of a second chunk of the document corresponding to a fourth time; and
after determining that the second checksum is different from the first checksum, replacing the first chunk and a corresponding first vector in the vector index by the second chunk and a corresponding second vector without replacing others of the chunks of the document in the vector index.

17. The method of claim 15, wherein the change indicated in the difference report is represented by a change indicator in the difference report, the change indicator is indicative of a document having a first name in the input data set at the first time and having a second name in the input data set at the second time, the generating of the vector embedding for the first portion of the input data set including generating an updated document identifier corresponding to the second name of the document.

18. The method of claim 15, further including in response to a change indicator in the difference report indicative of a document of the input data set at the second time being a modified version relative to the document in the input data set at the first time, updating the vector index by removing the document corresponding to the first time and inserting the modified version of the document in the vector index.

19. The method of claim 15, further including in response to a change indicator in the difference report indicative of a document in the input data set at the second time that is not in the input data set at the first time, updating the vector index by inserting the document in the vector index.

20. The method of claim 15, further including in response to a change indicator in the difference report indicative that a document of the input data set at the first time is not in the input data set at the second time, updating the vector index by removing a document identifier of the document from the vector index.

21. The method of claim 15, wherein the vector index with the re-indexed first portion is an updated vector index, the vector index having a first index object application programming interface (API) name, the method including inserting a second index object API name corresponding to the updated vector index in the refresh notification to the LLM query engine.
